(19) United States
(12) Patent Application Publication
(10) Pub. No.: US 2013/0240655 A1
(43) Pub. Date: Sep. 19, 2013

(54) WEBBING RETRACTOR

(71) Applicant: KABUSHIKI KAISHA TOKAI-RIKA-DENKI-SEISAKUSHO, Aichi-ken (JP)

(72) Inventors: Wataru YANAGAWA, Aichi-ken (JP); Masaru UKITA, Aichi-ken (JP); Yoshiaki MAEKUBO, Aichi-ken (JP)

(73) Assignee: KABUSHIKI KAISHA TOKAI-RIKA-DENKI-SEISAKUSHO, Aichi-ken (JP)

(21) Appl. No.: 13/796,325

(22) Filed: Mar. 12, 2013

(30) Foreign Application Priority Data
Mar. 16, 2012 (JP) 2012-060306

(51) Int. Cl. B60R 22/34

(52) U.S. Cl. CPC B60R 22/34
USPC 242/407

(57) ABSTRACT

In a webbing retractor, a press insertion portion of a sleeve provided to a webbing take-up shaft is press-inserted into a press insertion hole of a clutch base. Ribs are provided to an inner peripheral face of the press insertion hole, thereby enabling rattling between the sleeve and the clutch base to be suppressed. An end face of each rib on the opposite side to the press insertion direction of the press insertion portion is configured with a sloping faces that slopes along the press insertion direction, and so the sloping face makes sliding contact with the press insertion portion when the press insertion portion is being press-inserted into the press insertion hole. Burrs due to the press insertion portion being cut by the ribs can accordingly be prevented or suppressed from generating.

### CROSS-REFERENCE TO RELATED APPLICATION

This application claims priority under 35 USC 119 from Japanese Patent Application No. 2012-060306 filed Mar. 16, 2012, the disclosure of which is incorporated by reference herein.

### BACKGROUND OF THE INVENTION

1. Field of the Invention

The present invention relates to a webbing retractor equipped with a seat belt device employed for example in a vehicle.

2. Related Art

In a seat belt retractor disclosed in Japanese Patent Application Laid-Open (JP-A) No. 2002-104134 an axial direction hole is formed with a substantially hexagonal shaped cross-section in an axial center portion of a webbing take-up reel. A torque transmission shaft formed with a substantially hexagonal shaped cross-section to a torsion bar axial direction end portion is press-fitted to the axial direction hole. The torsion bar axial direction end portion is thereby connected so as to be capable of rotating as one with the reel. Moreover, rattle suppression ribs are respectively formed to three mutually non-adjacent sides of the inner peripheral face of the axial direction hole, such that rattling between the reel and the torsion bar is suppressed by the rattle suppression ribs.

In the seat belt retractor as described above, there is the possibility of unwanted burrs being generated by sliding contact between the rattle suppression ribs and the torque transmission shaft during press-fitting of the torque transmission shaft of the torsion bar (press insertion member) to the axial direction hole of the reel (pressed insertion member).

### SUMMARY OF THE INVENTION

In consideration of the above circumstances, the present invention is to provide a webbing retractor capable of preventing or suppressing burrs from generating during press insertion of a press insertion member to a pressed insertion member.

In order to address the above issue, a webbing retractor according to a first aspect of the invention is a webbing retractor including: a press insertion member that is provided at a webbing take-up shaft supported rotatably at a frame, and that includes a press insertion portion; and a pressed insertion member that is formed from a material harder than the press insertion member, and that includes a pressed insertion portion to which the press insertion portion is press-inserted, and a rib that is provided on a face of the pressed insertion portion facing the press insertion portion, wherein an end face of the rib, which end face is on the opposite side to a press insertion direction of the press insertion portion to the pressed insertion portion, is a sloping face that slopes along the press insertion direction or is a curved face that curves along the press insertion direction.

Note that in the first aspect “that slopes (curves) along the press insertion direction” means “that slopes (curves) towards the press insertion direction on progression towards the press insertion portion”.

Moreover, “harder” in the first aspect means any configuration in which the press insertion portion is deformed (including being cut or shaved) by sliding contact between the rib and the press insertion portion during press insertion of the press insertion member to the pressed insertion member.

In the first aspect of the invention, the press insertion portion of the press insertion member provided to the webbing take-up shaft is press inserted (press fit) to the pressed insertion portion of the pressed insertion member. The pressed insertion member is formed from a material harder than the press insertion member. The rib is provided on the face of the pressed insertion portion of the pressed insertion member, facing the press insertion portion of the press insertion member, enabling rattling (looseness) between the press insertion member and the pressed insertion member to be suppressed by the rib. Moreover, the end face of the rib on the opposite side to the press insertion direction of the press insertion portion is configured by the sloping face that slopes along the press insertion direction of the press insertion portion or the curved face that curves along the press insertion direction of the press insertion portion. The sloping face or the curved face makes sliding contact with the press insertion portion during insertion of the press insertion member to the pressed insertion member. Burrs can thereby be prevented or suppressed from being generated by cutting of the press insertion portion by the rib, enabling easy press insertion of the press insertion portion to the pressed insertion portion.

A webbing retractor according to a second aspect of the invention is the first aspect wherein the press insertion portion is press-inserted to the pressed insertion portion from one end side of the press insertion portion, and an abutting portion for positioning, that is provided at another end side of the press insertion portion, abuts an abutted portion which is provided at the pressed insertion member.

The second aspect of the invention can prevent or suppress burrs from being generated by the press insertion portion being cut by the rib during press insertion of the press insertion portion of the press insertion member to the pressed insertion portion from the one end side. As a result, good assembly precision can be achieved between the press insertion member and the pressed insertion member since burrs can be prevented from being sandwiched between the abutting portion which is for positioning and which is provided to the other end side of the press insertion portion and the abutted portion which is provided to the pressed insertion member.

A webbing retractor according to a third aspect of the invention is the second aspect wherein a space is formed between the end face of the rib and the abutting portion.

In the third aspect of the invention, the space is formed between the end face (the sloping face or the curved face) of the rib provided at the pressed insertion portion, which is on the opposite side to the press insertion direction of the press insertion portion, and the abutting portion provided at the press insertion member. Thus even were a burr to be generated at the press insertion portion due to sliding contact between the end face of the rib and the press insertion portion, such a burr can be confined (pocketed) within the space. As a result, the burr can be effectively prevented from becoming sandwiched between the abutting portion of the press insertion member and the abutted portion of the pressed insertion member.

A webbing retractor of a fourth aspect of the invention is the third aspect wherein the end face of the rib is provided so as to be separated, in the press insertion direction, from the abutted portion.

In the fourth aspect of the invention, the end face which is on the opposite side to the press insertion direction of the press insertion portion of the rib formed to the pressed insertion portion is provided so as to be separated in the press insertion direction from the abutted portion. The space between the end face of the rib and the abutting portion of the press insertion member is accordingly made larger. Thus even were a burr to be generated at the press insertion portion by sliding contact between the end face of the rib and the press insertion portion, the burrs can be well made closed within the space. Moreover, due to providing the end face of the rib separated in this manner from the abutted portion as described above, the length of sliding contact between the rib and the press insertion portion can be made shorter. Thus even in cases in which a burr is generated due to sliding contact between the rib and the press insertion portion, the volume of the burr can be reduced, with this being effective in such cases in which there is a long press insertion stroke of the press insertion portion with respect to the pressed insertion portion.

A webbing retractor according to a fifth aspect of the invention is any one of the first aspect to the fourth aspect, wherein the press insertion portion is press-inserted to the pressed insertion portion from one end side of the press insertion portion, a concave portion is formed at the one end side of the press insertion portion, into which the rib is inserted when the press insertion portion is press-inserted to the pressed insertion portion; and an end face of the concave portion on the opposite side to the press insertion direction of the press insertion portion is configured by a sloping face that slopes such that the concave portion becomes shallower on progression towards another end side of the press insertion portion.

In the fifth aspect of the invention, the rib formed to the pressed insertion portion is inserted into the concave (indentation) portion formed to the one end side of the press insertion portion during press insertion of the press insertion portion of the press insertion member to the pressed insertion portion of the pressed insertion member from the one end side. The end face of the concave portion on the opposite side to the press insertion direction of the press insertion portion is configured with a sloping face that slopes such that the concave portion becomes shallower on progression towards the other end side of the press insertion portion. Burrs are accordingly suppressed from being generated by sliding contact of the sloping face of the concave portion with the end face of the rib (the curved face or the sloping face) when the other end side of the press insertion portion is press inserted to the pressed insertion portion (when the rib comes out from the concave portion). Namely, were a step portion (corner portion, for example, vertical portion) to be formed to the concave portion in place of the sloping face, there would be a possibility of a burr being generated by the step portion (corner portion) being cut by the rib, however, such a situation can be avoided in the present aspect. Moreover, even in a case in which for example the press insertion member is formed by forging, bulging up (building up) of the press insertion portion in the vicinity of the sloping face of the concave portion accompanying formation of the concave portion can be suppressed. Burrs can accordingly be suppressed from being generated by sliding contact between such bulging up portion and the rib.

A webbing retractor of a sixth aspect of the invention is any one of the first aspect to the fifth aspect, wherein the webbing take-up shaft comprises a spool on which webbing is taken up, and a torsion shaft that has one end portion connected to the spool; the press insertion member is a sleeve that is attached to another end portion of the torsion shaft; and the pressed insertion member is a clutch base that is attached to the sleeve and that connects a ring portion provided on a side of the frame and the sleeve via a pawl.

In the sixth aspect of the invention, the press insertion portion provided to the sleeve is press inserted to the pressed insertion portion provided to the clutch base, and the clutch base connects together the ring portion provided on the frame side and the sleeve via the pawl, restricting rotation of the sleeve with respect to the frame. The sleeve is attached to the other end portion of the torsion shaft that has its one end connected to the spool, and the torsion shaft thereby undergoes twisting deformation when excess tension force acts on the webbing in the sleeve rotation restricted state. Energy absorption can thereby be achieved. Moreover, since in the present aspect, burrs can be prevented or suppressed from being generated during press insertion of the press insertion portion provided to the sleeve into the pressed insertion portion provided to the clutch base, good assembly precision can be achieved for example between the sleeve and the clutch base. As a result, the engagement precision can be raised when the clutch base engages the pawl and the ring portion.

A webbing retractor of a seventh aspect of the invention is any one of the first aspect to the fifth aspect, wherein the webbing take-up shaft comprises a spool on which webbing is taken up, and a torsion shaft that is connected to the spool; the press insertion member is the spool, the pressed insertion member is the torsion shaft, and the rib is formed on the pressed insertion portion provided at an end portion in an axial direction of the torsion shaft.

In any one of the first aspect to the seventh aspect, it is possible that the rib is formed so as to protrude from the pressed insertion portion toward a side of the press insertion portion, and a protruding height of the sloping face of the rib or the curved face of the rib becomes lower on progression towards the opposite side to the press insertion direction of the press insertion portion.

In the sixth aspect, it is possible that the pressed insertion portion is a hole that passes through the pressed insertion member in an axial direction of the webbing take-up shaft, the rib is formed so as to protrude from an inner peripheral face of the hole toward a side of an outer peripheral face of the press insertion portion, and a protruding height of the sloping face of the rib or the curved face of the rib becomes lower on progression towards the opposite side to the press insertion direction of the press insertion portion.

In the seventh aspect, it is possible that the press insertion portion is a hole portion that is provided at an axial center portion of the press insertion member, the rib is formed so as to protrude from an outer peripheral face of the pressed insertion portion toward a side of an inner peripheral face of the hole portion, and a protruding height of the sloping face of the rib or the curved face of the rib becomes lower on progression towards the opposite side to the press insertion direction of the press insertion portion.

As explained above, in the webbing retractor according to the present invention, burrs can be prevented or suppressed from being generated during press insertion of the press insertion member to the pressed insertion member.

### BRIEF DESCRIPTION OF THE DRAWINGS

Embodiments of the invention will be described in detail with reference to the following figures, wherein:

FIG. 1 is an exploded perspective view illustrating a configuration of relevant portions of a webbing retractor according to a first exemplary embodiment of the present invention;

FIG. 2 is an exploded perspective view illustrating a configuration of a clutch mechanism that is a configuration member of the webbing retractor;

FIG. 3 is a diagram of the clutch mechanism as viewed from the opposite side to that of a spool;

FIG. 4A is a diagram illustrating a state when clutch plates of the clutch mechanism have started to rotate towards a lock ring side;

FIG. 4B is a diagram illustrating a state in which the clutch plates have meshed with a lock ring;

FIG. 5 is an exploded perspective view illustrating a configuration of a switching mechanism that is a configuration member of the webbing retractor;

FIG. 6 is a face-on view of a clutch base that is a configuration member of the clutch member;

FIG. 7 is a perspective view illustrating a configuration of part of the clutch base;

FIG. 8 is a cross-section illustrating a section along line 8-8 of FIG. 6;

FIG. 9A is a perspective view illustrating a state partway through press insertion of a sleeve of the clutch mechanism into the clutch base;

FIG. 9B is a perspective view illustrating a fully press-inserted state of the sleeve into the clutch base

FIG. 10A is a cross-section illustrating a state partway through press insertion of the sleeve of the clutch mechanism into the clutch base;

FIG. 10B is a cross-section illustrating a fully press-inserted state of the sleeve of the clutch mechanism into the clutch base;

FIG. 11 is a cross-section for explaining a state when a rib of the clutch base makes sliding contact with the press insertion portion of the sleeve;

FIG. 12 is a perspective view corresponding to FIG. 7 and illustrating a configuration of portions of a clutch base provided to a clutch mechanism that is a configuration member of a webbing retractor according to a second exemplary embodiment of the present invention;

FIG. 13 is a cross-section illustrating a cross-section taken along line 13-13 of FIG. 12;

FIG. 14A is a cross-section illustrating a state partway through press insertion of a sleeve of the clutch mechanism into the clutch base;

FIG. 14B is a cross-section illustrating a fully press-inserted state of the sleeve into the clutch base;

FIG. 15 is a cross-section illustrating part of a configuration of a webbing retractor according to a third exemplary embodiment of the present invention; and

FIG. 16 is a cross-section illustrating a modified exemplary embodiment of the present invention.

### DETAILED DESCRIPTION OF THE INVENTION

### First Embodiment

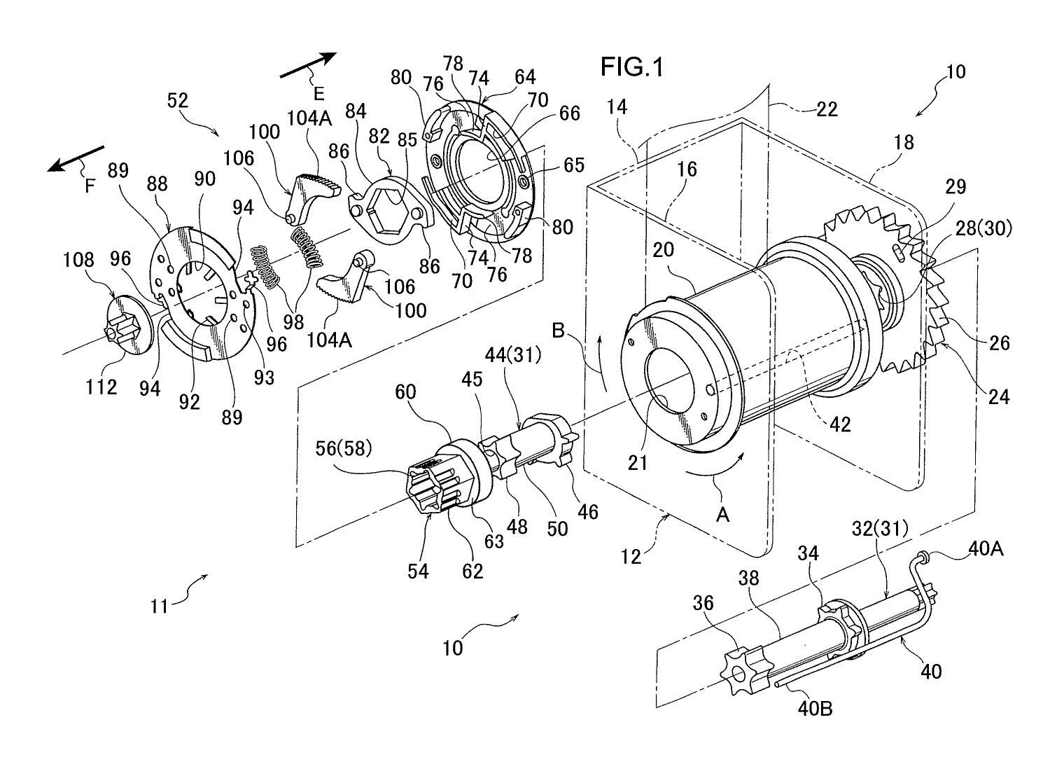

A webbing retractor 10 relating to a first embodiment of the present invention is described hereinafter by using FIG. 1 through FIG. 11.

As shown in FIG. 1 through FIG. 5, the webbing retractor 10 relating to the present first embodiment has a frame 12, a webbing 22, a webbing take-up shaft 11, and a switching mechanism 120.

As shown in FIG. 1, the frame 12 has a plate-shaped back plate 14 that is fixed to the vehicle body. Leg pieces 16, 18 extend substantially orthogonally from the vehicle transverse direction both end portions of the back plate 14, and the frame 12 is formed in a substantially concave shape as seen in plan view. Note that a known locking mechanism is mounted to the outer side of the leg piece 18. Further, the webbing 22 is applied to the body of a passenger, and is formed in an elongated belt shape.

Structure of Webbing Take-Up Shaft 11

The webbing take-up shaft 11 has a spool 20, a lock gear 24 serving as a lock section, a main torsion shaft 32, a trigger wire 40, a sub torsion shaft 44 and a clutch mechanism 52. The main torsion shaft 32 and the sub torsion shaft 44 configure a force limiter mechanism 31.

The spool 20 is formed in a cylindrical tube shape having a through-hole 21 that passes through in the axial direction, and is disposed between the leg piece 16 and the leg piece 18 of the frame 12. The spool 20 is disposed in a state in which the axial direction thereof is along the direction in which the leg piece 16 and the leg piece 18 oppose one another. The spool 20 is rotatably supported at the frame 12 via the main torsion shaft 32, the sub torsion shaft 44 and the like. A longitudinal direction one end portion (a proximal (base) end portion) of the webbing 22 is anchored on the spool 20. Due to the spool 20 rotating in a take-up direction (the direction of arrow A in FIG. 1 and the like) that is one rotating direction, the webbing 22 is taken-up and accommodated from the proximal end side thereof.

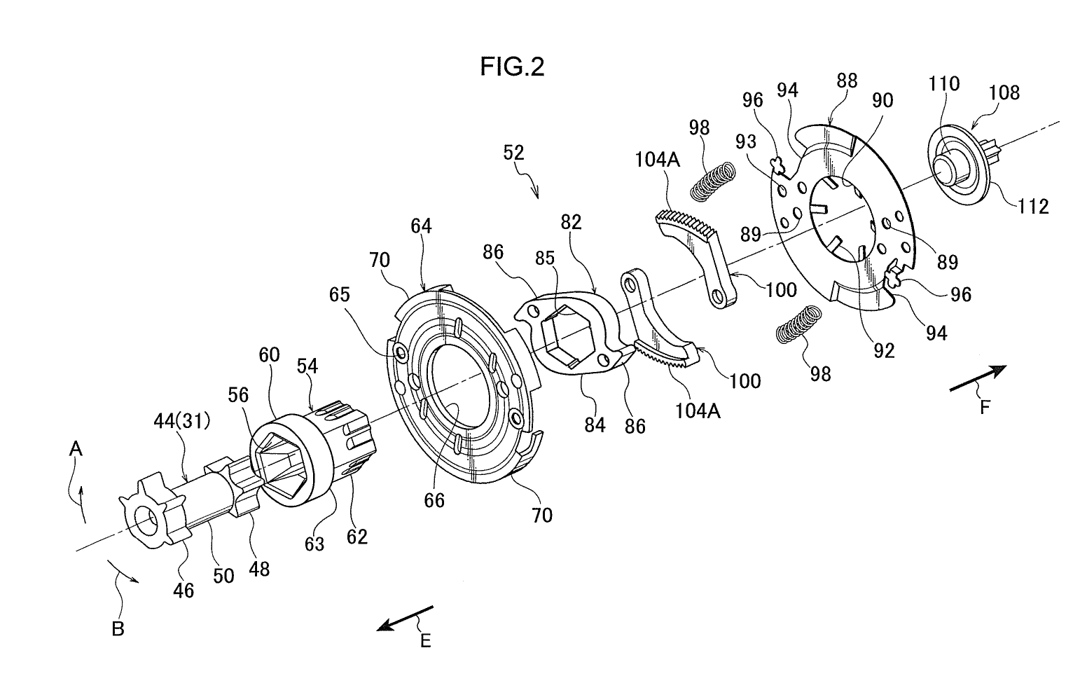

The lock gear 24 is disposed coaxially to the spool 20 at an axial direction one side of the spool 20 (the arrow E direction side in FIG. 1 and FIG. 2). A gear portion 26 is formed at the outer peripheral portion of the lock gear 24. Further, a through-hole 28, that passes through in the axial direction, is formed at the axially central portion of the lock gear 24. An engaged portion 30 that is spline-shaped is formed at the inner peripheral portion of the through-hole 28.

At the time of an emergency of the vehicle (a predetermined occasion such as rapid deceleration or the like), due to the aforementioned locking mechanism detecting that the acceleration (in particular, the decelerating acceleration) of the vehicle is greater than or equal to a predetermined acceleration, or detecting that the pull-out acceleration of the webbing 22 from the spool 20 is greater than or equal to a specific acceleration, and operating, a locking member (not illustrated in the drawings) of the locking mechanism engages with the gear portion 26 of the lock gear 24, and rotation of the lock gear 24 in the pull-out direction (the direction of arrow B in FIG. 1 and the like) is impeded (locked).

The main torsion shaft 32 is disposed coaxially with the spool 20 and the lock gear 24, and is inserted through the through-hole 21 of the spool 20 and the through-hole 28 of the lock gear 24, respectively. A first engagement portion 34 that is spline-shaped is formed at the longitudinal direction central portion of the main torsion shaft 32. A second engagement portion 36 that is similarly spline-shaped is formed at the distal end portion of the main torsion shaft 32.

Further, due to the first engagement portion 34 being fit-together with and anchored by the engaged portion 30 of the lock gear 24, the main torsion shaft 32 is connected to (anchored on) the lock gear 24 so as to be able to rotate integrally therewith. Further, due to the second engagement portion 36 being fit-together with and anchored by an unillustrated engaged portion that is formed at the axial direction intermediate portion of the inner peripheral portion of the spool 20, the main torsion shaft 32 is connected to (anchored on) the spool 20 so as to be able to rotate integrally therewith.

The portion between the first engagement portion 34 and the second engagement portion 36 at the main torsion shaft 32 is structured as a first energy absorbing portion 38 that is for absorbing kinetic energy of the passenger that is used to pull the webbing 22 as is described later.

A proximal end portion 40A of the trigger wire 40 is inserted in a hole portion 29 that is formed at a position that is further toward the radial direction outer side than the through-hole 28 at the lock gear 24, and is anchored at the lock gear 24. On the other hand, the portion of the trigger wire 40 that is further toward the distal end side than the proximal end portion 40A thereof is inserted in a hole portion 42 that is formed in the spool 20 in parallel with the through-hole 21. A distal end portion 40B of the trigger wire 40 projects-out from the spool 20 toward the axial direction other side (the arrow F direction side in FIG. 1 and FIG. 2).

The sub torsion shaft 44 is disposed coaxially with the main torsion shaft 32. The portion of the sub torsion shaft 44 that is further toward the proximal end side than the longitudinal direction central portion thereof is inserted in the through-hole 21 of the spool 20. On the other hand, the portion of the sub torsion shaft 44 that is further toward the distal end side than the longitudinal direction central portion thereof projects-out from the spool 20 toward the axial direction other side.

A first engagement portion 46 that is spline-shaped at least one portion thereof is formed at the proximal end portion of the sub torsion shaft 44. A second engagement portion 48 that is similarly spline-shaped is formed at the distal end portion of the sub torsion shaft 44. The first engagement portion 46 is engaged with an engaged portion (not shown in the drawings) that is formed at the axial direction intermediate portion of the inner peripheral portion of the spool 20. Due thereto, the sub torsion shaft 44 is connected to (anchored on) the spool 20 so as to be able to rotate integrally therewith.

Further, the portion between the first engagement portion 46 and the second engagement portion 48 at the sub torsion shaft 44 is structured as a second energy absorbing portion 50 for absorbing the kinetic energy of the passenger that is used to pull the webbing 22 as is described later.

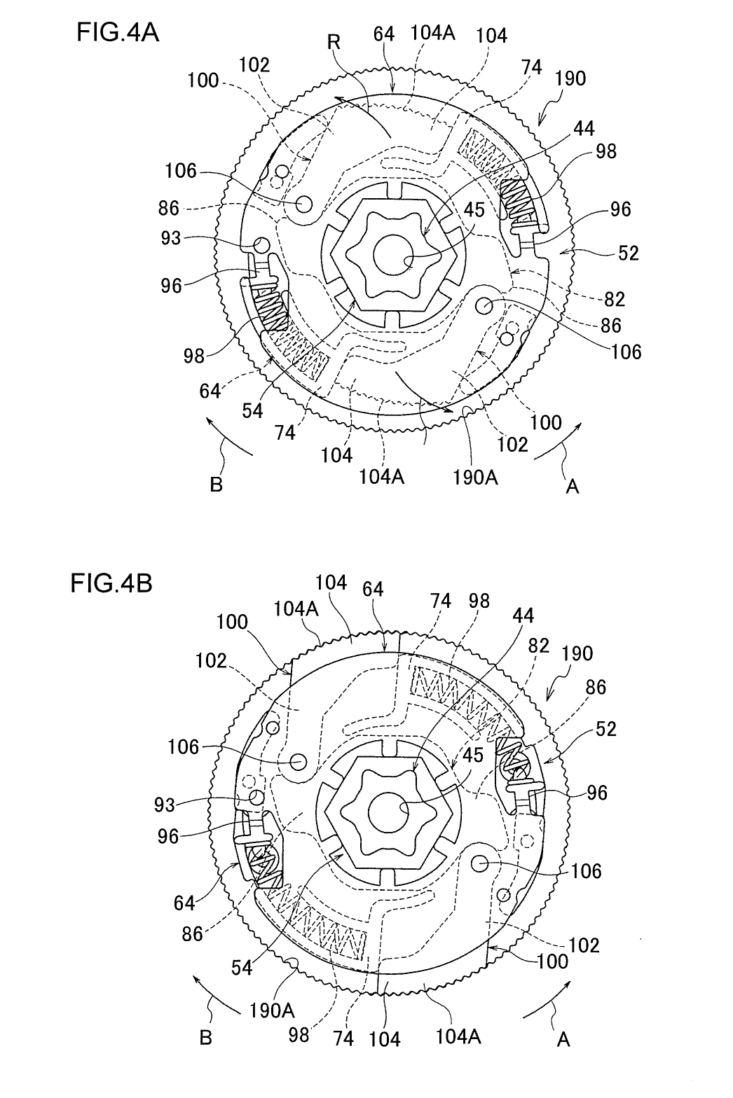

As illustrated in FIG. 1 and FIG. 2, the clutch mechanism 52 includes a sleeve 54 serving as a press insertion (press fit) member, a clutch guide 64, a clutch base 82 serving as a pressed insertion (pressed fit) member, a clutch cover 88, a pair of clutch plates 100 serving as pawls, a screw 108 and a pair of coil springs 98. Note that a state in the midst of operation of the clutch mechanism 52 is shown in FIG. 4A, and a state after operation of the clutch mechanism 52 is completed is shown in FIG. 4B.

The sleeve 54 is disposed coaxially to the sub torsion shaft 44. A through hole 56 is formed to an axial center potion of the sleeve 54, passing through along the axial direction. The sub torsion shaft 44 is inserted into the through hole 56 with play therebetween. A spline shaped engaged portion 58 is formed at the distal end side of an inner peripheral portion of the sleeve 54. The sleeve 54 is connected (anchored) so as to be capable of rotation as integrally with the sub torsion shaft 44 due to the second engagement portion 48 of the sub torsion shaft 44 engaging with the engaged portion 58

The proximal end side of the sleeve 54 is structured as a supporting portion 60 having a circular cylinder shaped external profile, and a portion of the sleeve 54 that is further toward the distal end side than the supporting portion 60 is structured as a press insertion (press fit) portion 62 that is formed in a regular hexagonal shape in cross-section.

The clutch guide 64 is made of resin, and is formed in an annular shape having a through-hole 66 that passes through in the axial direction. The above-described supporting portion 60 is inserted in this through-hole 66, and due thereto, the clutch guide 64 is supported at the sleeve 54 so as to be able to rotate relative thereto.

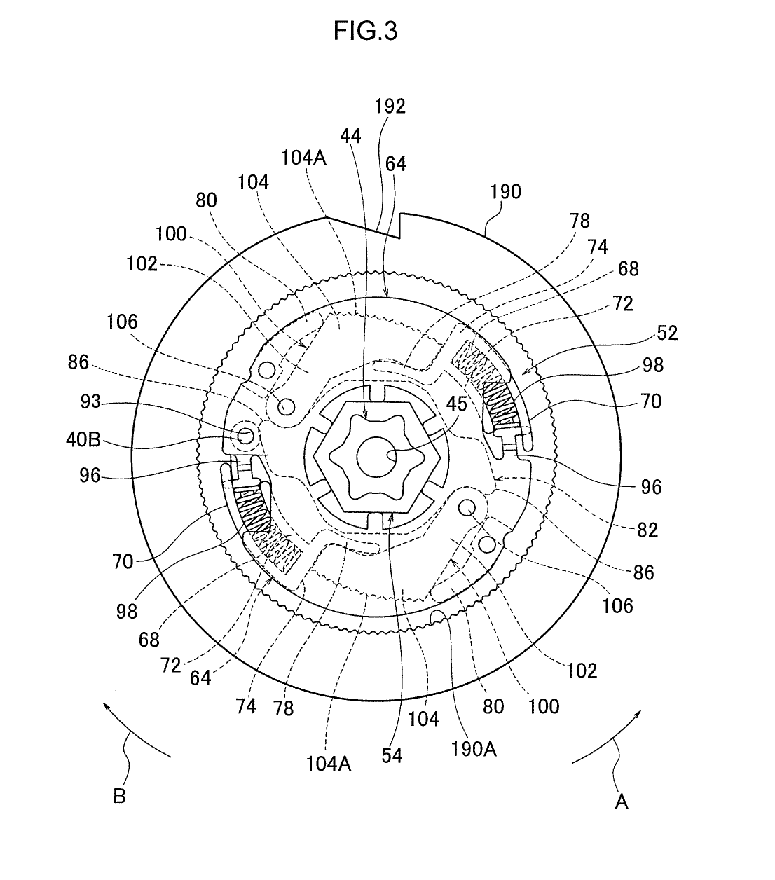

As shown in FIG. 3, a pair of coil spring accommodating portions 68, that accommodate the coil springs 98, are formed at positions at two places in the peripheral direction at the clutch guide 64. These coil spring accommodating portions 68 are formed in shapes having point symmetry around the central portion of the clutch guide 64. Each of the coil spring accommodating portions 68 is formed in a substantial U-shape having an outer side wall portion 70 and an inner side wall portion 72 that extend in the peripheral direction of the clutch guide 64, and a connecting wall portion 74 that extends in the radial direction of the clutch guide 64 and connects respective end portions of the outer side wall portion 70 and the inner side wall portion 72.

Further, a pair of clutch plate accommodating portions 76 that accommodate the clutch plates 100 are formed in the clutch guide 64 adjacent to the respective coil spring accommodating portions 68. A first supporting wall portion 78 that extends from the connecting wall portion 74 toward the side opposite the inner side wall portion 72, and a second supporting wall portion 80 that is apart from the connecting wall portion 74 at the side of the connecting wall portion 74 opposite the side at which the outer side wall portion 70 is located, are formed at these clutch plate accommodating portions 76.

The clutch base 82 is structured to have a base main body 84 that is annular. A press insertion (press fit) hole 85 (pressed insertion (pressed fit) portion) that is shaped as a regular hexagon in cross-section is formed in the base main body 84. The press insertion portion 62 of the sleeve 54 is press-inserted into (fit to) this press insertion hole 85, and, due thereto, the clutch base 82 is fixed to the sleeve 54 so as to be able to rotate integrally therewith. Further, a pair of anchor portions 86 that project-out toward the outer side from the base main body 84 are formed at the clutch base 82. These anchor portions 86 are anchored on the proximal end portions of arm portions 102 that are formed at the clutch plates 100 that are described later.

The clutch cover 88 is disposed coaxially to the sleeve 54, and is disposed so as to face the clutch guide 64, at the side of the clutch guide 64 opposite the side at which the spool 20 is located. The clutch cover 88 is formed in an annular shape having a through-hole 90 that passes through in the axial direction. Plural fit-together claws 92, that project-out toward the radial direction inner side, are formed at the inner peripheral portion of the clutch cover 88. Further, due to the press insertion portion 62 of the sleeve 54 being inserted into the through-hole 90 and the plural fit-together claws 92 being fit-together with the press insertion portion 62, the clutch cover 88 is fixed to the sleeve 54, and accordingly to the sub torsion shaft 44, so as to be able to rotate integrally therewith. Further, cross-shaped claws 96, that are described later, of the clutch cover 88 engage with the clutch guide 64 in the peripheral direction, and the clutch guide 64 is made able to rotate relative to the clutch cover 88 between an operation position shown in FIG. 4B and a non-operation position shown in FIG. 3.

Cut-out portions 94, that are formed in concave shapes as seen in the axial direction and that open toward the radial direction outer side, are respectively formed at positions of two places in the peripheral direction at the clutch cover 88. Further, the pair of cross-shaped claws 96 are formed at the clutch cover 88 so as to be positioned at the inner sides of the respective cut-out portions 94. This pair of cross-shaped claws 96 is formed in shapes that are point symmetrical around the central portion of the clutch cover 88. Moreover, these cross-shaped claws 96 are bent in crank shapes as seen from the radial direction of the clutch cover 88, and the distal end sides thereof project-out further toward the clutch guide 64 side than the proximal end sides thereof.

An inner side projecting portion that projects-out toward the radial direction inner side of the clutch guide 64, an outer side projecting portion that projects-out toward the radial direction outer side of the clutch guide 64, and a peripheral direction projecting portion that projects-out in one peripheral direction of the clutch guide 64 (the take-up direction), are provided at the distal end sides of each of the cross-shaped claws 96. The distal end sides of each of the cross-shaped claws 96 are formed in the shape of a cross as seen from the axial direction of the clutch guide 64.

The clutch plates 100 are disposed between the clutch cover 88 and the clutch guide 64. The clutch plates 100 have the arm portions 102, and arc-shaped portions 104 that are formed at the distal end portions of the arm portions 102. Rotating shafts 106, that project-out toward the clutch cover 88 side and extend along the axial direction of the sub torsion shaft 44, are formed at the proximal end portions of the arm portions 102. The clutch plates 100 are rotatably supported at the clutch cover 88 due to the rotating shafts 106 being inserted in hole portions 89 that are formed in the clutch cover 88. Further, flat-tooth-shaped knurled teeth 104A are formed at the outer peripheral portions of the arc-shaped portions 104 (the distal end portions of the clutch plates 100).

The screw 108 has a screw portion 110, and a pushing portion 112 that has a larger diameter than the screw portion 110. The screw portion 110 is screwed-together with a screw hole 45 that is formed in the distal end portion of the sub torsion shaft 44. Due thereto, the screw 108 is fixed to the distal end portion of the sub torsion shaft 44. Further, in the state in which the screw 108 is fixed to the distal end portion of the sub torsion shaft 44 in this way, the pushing portion 112 abuts the distal end portion of the sleeve 54. Due thereto, movement of the sleeve 54 in the direction of coming-off from the sub torsion shaft 44 is limited. In this state, axial direction movement of the clutch guide 64 is limited by the clutch cover 88 and the spool 20.

Further, hole portions 65, 91 are formed in the above-described clutch guide 64 and clutch cover 88, respectively. These hole portions 65, 91 are formed so as to face one another in the state in which the clutch guide 64 is disposed at the non-operation position with respect to the clutch cover 88. The distal end portion 40B of the trigger wire 40 is inserted respectively into these hole portions 65, 91. Due thereto, in the state in which the clutch guide 64 is disposed at the non-operation position, relative rotation of the clutch guide 64 with respect to the spool 20 and the clutch cover 88 is limited (the clutch guide 64 is restrained at the non-operation position).

Still further, in the state in which the clutch guide 64 is restrained at the non-operation position as described above, the respective cross-shaped claws 96 of the clutch cover 88 are disposed in vicinities of the opening portions at the respective coil spring accommodating portions 68 of the clutch guide 64. Further, the peripheral direction projecting portions of the respective cross-shaped claws 96 are inserted into the inner sides of the coil springs 98 from axial direction one end portions of the coil springs 98 that are accommodated in the respective coil spring accommodating portions 68. The inner side projecting portions and the outer side projecting portions of the respective cross-shaped claws 96 abut the axial direction one end portions of the coil springs 98. Due thereto, the axial direction one end portions of the coil springs 98 are anchored on the respective cross-shaped claws 96. Further, the axial direction other end portions of the coil springs 98 are anchored on the connecting wall portions 74 (see FIG. 3) of the coil spring accommodating portions 68.

In this state, the intervals between the cross-shaped claws 96 and the connecting wall portions 74 are shorter than the full lengths in the free states of the coil springs 98, and, due thereto, the coil springs 98 are in compressed states. Further, due thereto, urging force in the take-up direction is imparted to the clutch guide 64, and the clutch guide 64 is urged toward the operation position.

On the other hand, in this state, there is a state in which the intervals between the hole portions 89 of the clutch cover 88 (the rotating shafts 106 of the clutch plates 100) and the connecting wall portions 74 are sufficiently ensured, and the clutch plates 100 are accommodated in the clutch plate accommodating portions 76 such that the knurled teeth 104A are kept further toward the inner side than the outer peripheral portion of the clutch guide 64. Further, in this state, the connecting wall portions 74 abut the distal ends of the arc-shaped portions 104.

(Structure of Switching Mechanism 120)

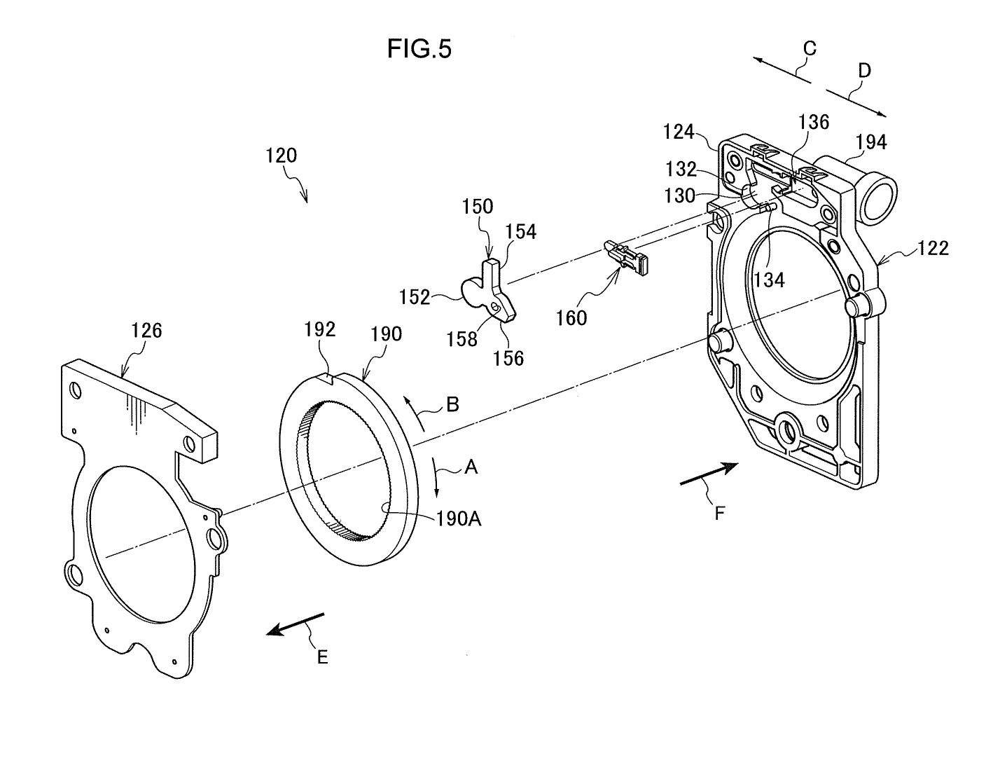

As shown in FIG. 5, the switching mechanism 120 has the body 122 that is box shaped. The interior of the body 122 is open toward the leg piece 16 side of the frame 12, and the body 122 is fixed to the outer side of the leg piece 16. A lock ring 190 (link portion) that is substantially annular plate shaped is supported so as to rotate freely at the interior of the body 122. The lock ring 190 serving as a ring portion is disposed coaxially to the clutch mechanism 52, at the outer peripheral side of the clutch mechanism 52. Further, flat-tooth-shaped knurled teeth 190A are formed at the inner peripheral portion of the lock ring 190. Moreover, a lock hole 192, that is substantially triangular in cross-section, is formed to pass through the outer peripheral portion of the lock ring 190. The lock hole 192 opens toward the radial direction outer side of the lock ring 190.

A case portion 124, that serves as a housing portion that houses a pawl 150, a piston 160, and a gas generator 194 that are described later, is provided at the upper portion of the body 122. Further, a substantially plate-shaped sheet 126 is provided at the leg piece 16 side of the body 122, and the sheet 126 closes-off the opening portion of the body 122.

A concave portion 130 that opens toward the leg piece 16 side is provided at the case portion 124. A supporting portion 132, that is substantially C-shaped in cross-section, is formed at the concave portion 130. The supporting portion 132 supports a shaft portion 152 of the pawl 150, that is described later, so as to rotate freely. Further, a shear pin 134 that is solid cylindrical is provided integrally with the case portion 124 at the interior of the concave portion 130, and the shear pin 134 projects-out toward the leg piece 16 side. A piston accommodating portion 136 is provided within the concave portion 130. The piston 160, that is manufactured of resin, is accommodated within the piston accommodating portion 136 so as to be able to move rectilinearly in the longitudinal direction of the piston accommodating portion 136 (the arrow C direction and the arrow D direction in FIG. 5).

The pawl 150 that is substantially plate-shaped is accommodated within the concave portion 130 of the case portion 124. The shaft portion 152, that is substantially circular in cross-section, is provided at the pawl 150 at the portion thereof at the supporting portion 132 side of the concave portion 130, and the shaft portion 152 is supported at the supporting portion 132 so as to rotate freely. Further, the pawl 150 has a substantially L-shaped arm portion 154. An engaging portion 156 is provided at the proximal end portion of the arm portion 154. The distal end of the engaging portion 156 is disposed within the lock hole 192 of the lock ring 190 (at a locking position), and is engaged with the lock ring 190. Moreover, an anchor hole 158, that is circular in cross-section, is formed so as to pass through the proximal end portion of the arm portion 154. The aforementioned shear pin 134 is inserted through the anchor hole 158 interior, and rotation of the pawl 150 is limited.

Further, the gas generator 194, that is substantially solid cylindrical, is incorporated within the case portion 124 at a region that is at the side of the piston accommodating portion 136 opposite the side at which the leg piece 16 is located. The gas generator 194 communicates with the piston accommodating portion 136. The control device (not illustrated in the drawings) of the vehicle is electrically connected to this gas generator 194. At the time when the gas generator 194 is operated due to control of the control device, the gas generator 194 generates gas, and this gas is supplied to a cylinder portion 140 of the piston accommodating portion 136.

The aforementioned control device is electrically connected to a collision detection unit that is not illustrated in the drawings. The collision detection unit predicts a collision of the vehicle by, for example, an acceleration sensor that senses the acceleration (a sudden deceleration in particular) of the vehicle, or a distance measuring sensor that detects the distance to an obstacle in front of the vehicle, or the like. Further, the collision detection unit is structured so as to detect that the vehicle has collided, due to the acceleration sensor sensing a collision acceleration that is greater than or equal to a predetermined reference value.

Moreover, the control device is electrically connected to a physique detection unit that is not illustrated in the drawings. The physique detection unit detects the physique of the passenger seated in the seat by, for example, a load sensor, a belt sensor, a seat position sensor, or the like. Concretely, a load sensor detects the load that is applied to a seat of the vehicle, and the physique detection unit detects the physique of the passenger in accordance with the detected load. Further, a belt sensor detects the amount of the webbing 22 that is pulled-out from the spool 20, and the physique detection unit detects the physique of the passenger in accordance with the detected pulled-out amount. Moreover, a seat position sensor is structured by a position detection sensor that detects the slid position of the vehicle seat in the front-back direction, or by a camera sensor that is provided in the vehicle cabin, and the physique detection unit detects the physique of the passenger in accordance with the position of the seat detected by the seat position sensor.

The gas generator 194 is operated by the control device in a case in which the control device judges, on the basis of a signal from the physique detection unit, that the physique of the passenger is less than a predetermined reference value, and judges, on the basis of a signal from the collision detection unit, that the vehicle has collided. Due thereto, gas is supplied from the gas generator 194 to the interior of the piston accommodating portion 136. When gas is supplied to the interior of the piston accommodating portion 136, due to the pressure of this gas, the piston 160 moves toward the arm portion 154 side of the pawl 150. Due thereto, the piston 160 pushes the arm portion 154, and rotational force is thereby applied to the pawl 150. Due to the pawl 150 rotating toward a lock releasing position while breaking the shear pin 134 due to this rotational force, the engaging portion 156 of the pawl 150 is pulled-out from the lock hole 192 of the lock ring 190. Note that due to an elastic hook, that is provided at the outer peripheral portion of the piston 160, catching on a step portion that is formed at the inner peripheral portion of the piston accommodating portion 136, movement of the piston 160, that has moved toward the arm portion 154 side, toward the side opposite the arm portion 154 is restricted.

Main Portions of a First Embodiment

In a first exemplary embodiment, the press insertion hole 85 of regular hexagonal shaped cross-section is formed to the base main body 84 of the clutch base 82 which is provided at the clutch mechanism 52. The press insertion portion 62 of regular hexagonal shaped cross-section provided to the sleeve 54 is press-inserted (press fit) into the press insertion hole 85. The sleeve 54 is formed from a metal material (for example from a cold forging steel member), and the clutch base 82 is formed from a metal material harder than the sleeve 54 (for example from a high tensile steel plate).

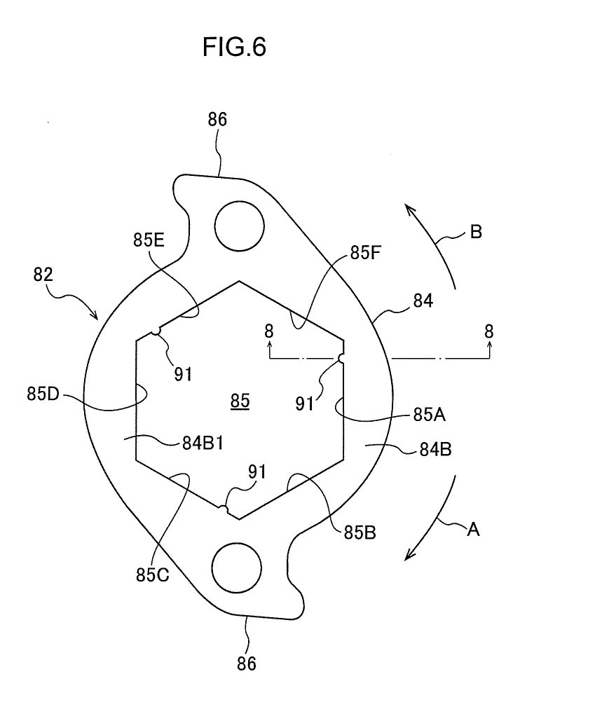

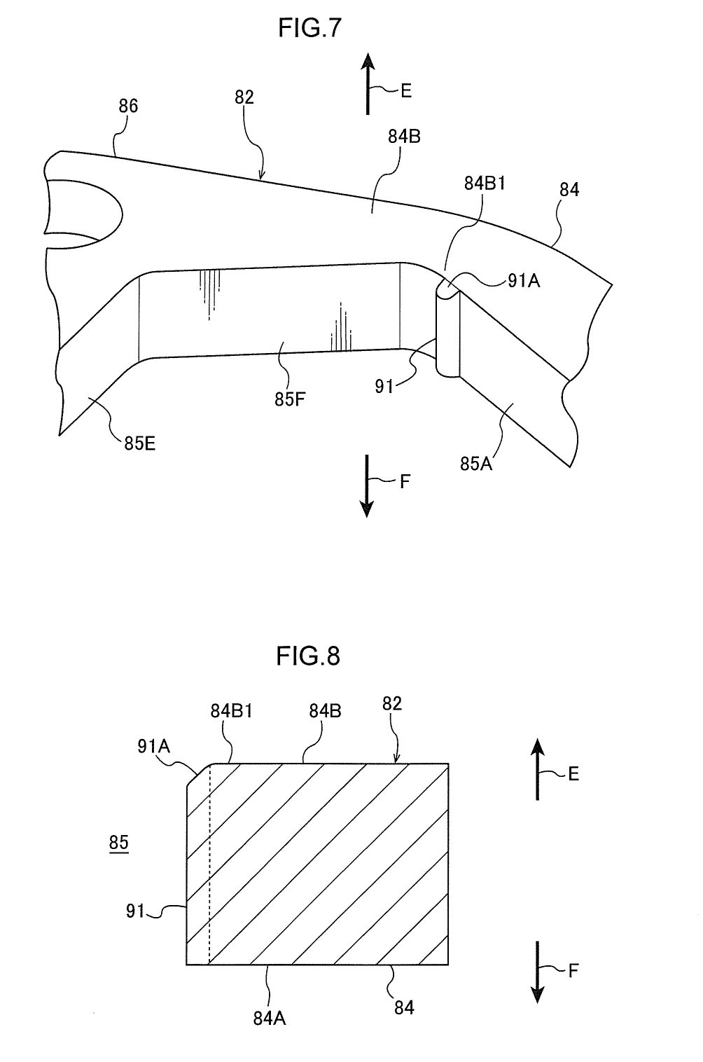

As illustrated in FIG. 6, the inner peripheral face of the press insertion hole 85 of the clutch base 82, namely the face facing to the press insertion portion 62, is formed with plural (three in this case) ribs 91. The ribs 91 are provided to suppress rattling (looseness) between the sleeve 54 and the clutch base 82, and are formed at three mutually non-adjacent sides (faces) 85A, 85C, 85E on the inner peripheral face of the press insertion hole 85. The ribs 91 are not formed on the other three sides (faces) 85B, 85D, 85F. The ribs 91 are formed with semicircular shaped cross-sections as viewed along the thickness direction of the clutch base 82 (a direction perpendicular to the plane of the paper in FIG. 6). (The ribs 91 are formed so as to protrude toward the axial center side of the press insertion hole 85.) The ribs 91 are also, as illustrated in FIG. 7, formed in elongated shapes along the clutch base 82 thickness direction. Note that, as shown in FIG. 6, each of the ribs 91 is disposed further to the pull-out direction side (the arrow B direction in FIG. 6) than the center of the respective three sides 85A, 85C, 85E.

As illustrated in FIG. 8, one length direction end face of each of the ribs 91 (the face on the lower side in FIG. 8) is formed in the same plane as one thickness direction end face 84A of the clutch base 82. The other length direction end face of each of the ribs 91 (the face on the upper side in FIG. 8) is configured with a sloping face 91A (C face (Chamfer-face)) that slopes downwards on progression towards the center side of the press insertion hole 85 from another thickness direction end face 84B of the clutch base 82. The angle of slope of the sloping faces 91 A with respect to the other thickness direction end face 84B of the clutch base 82 is set at, for example, 45 degrees, so as to slope along the press insertion direction of the press insertion portion 62 (the arrow F direction in FIG. 8). Namely, in a state in which the press insertion portion 62 is press inserted into the press insertion hole 85, each of the sloping faces 91A slopes towards the press insertion direction of the press insertion portion 62 on progression towards the outer peripheral face of the press insertion portion 62, in the other words, a protruding height of each of the sloping faces 91A (ribs 91) becomes lower on progression towards the opposite side to the press insertion direction of the press insertion portion 62.

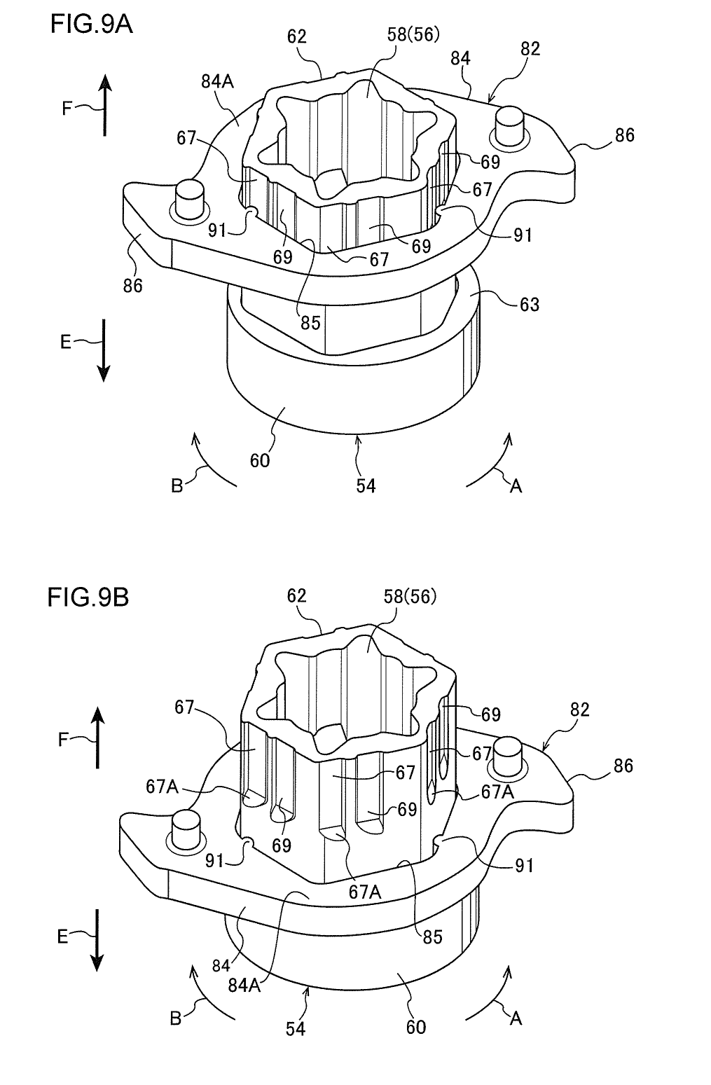

When press-insert the press insertion portion 62 of the sleeve 54 into the press insertion hole 85 of the clutch base 82, configuration is such that the press insertion portion 62 is inserted from the side formed with the sloping faces 91 A of the ribs 91. Namely configuration is made such that the press insertion portion 62 is press inserted into the press insertion hole 85 from the other thickness direction end face 84B side of the clutch base 82 (see FIG. 9A and FIG. 9B).

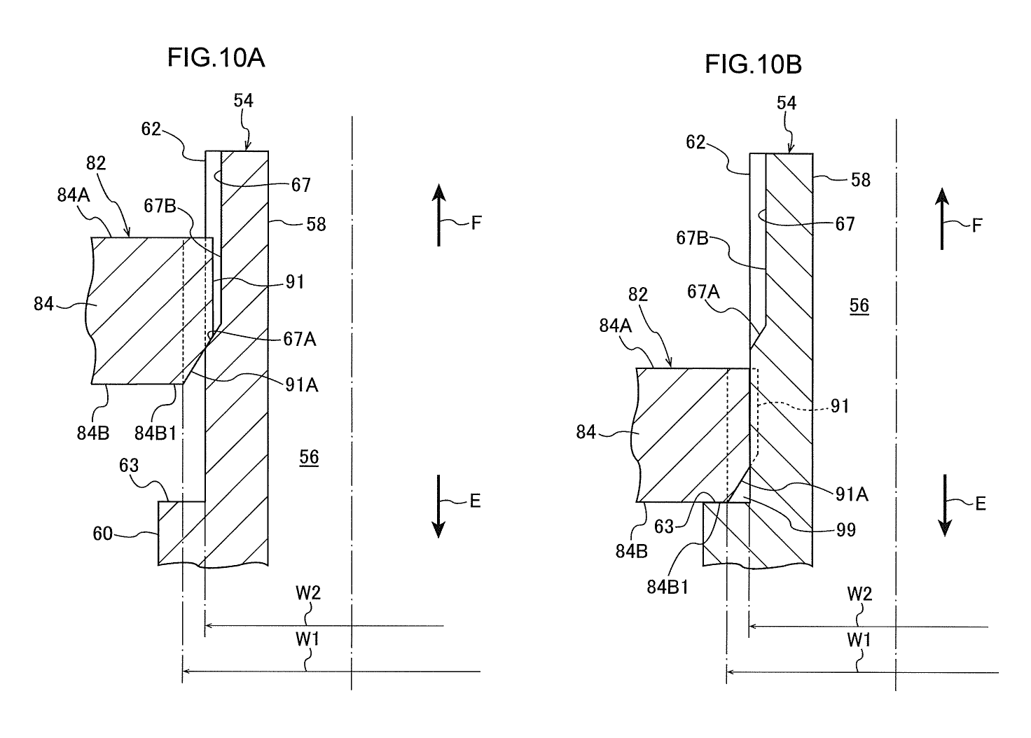

Plural (six in this case) indentation portions (concave portions) 67 are formed on the outer peripheral face of the press insertion portion 62 of the sleeve 54 to correspond to the plural ribs 91. The indentation portions 67 are formed respectively to the six faces configuring the outer peripheral face of the press insertion portion 62. The indentation portions 67 are formed in rectangular shapes as viewed along the sleeve 54 radial direction, and are each formed extending from the leading end portion (the end portion on the opposite side to the supporting portion 60) of the press insertion portion 62 to the vicinity of intermediate portion of the press insertion portion 62. Each of the indentation portions 67 is, as illustrated in FIG. 10A, configured such that an end face at the opposite side of the indentation portion 67 to the leading end portion of the press insertion portion 62 is a sloping face 67A that slopes with respect to the sleeve 54 axial direction (the arrow E direction and the arrow F direction in FIG. 10A). The sloping faces 67A are formed to slope such that the indentation portions 67 become shallower on progression towards the base end side of the press insertion portion 62. A bottom face 67B of each of the indentation portions 67 is connected to the outer peripheral face of the base end side of the press insertion portion 62 though the sloping face 67A. Note that indentation portions (concave portions) 69 are formed to the outer peripheral face of the press insertion portion 62 of the sleeve 54 respectively adjacent to each of the above indentations 67. Configuration is such that the fitting claws 92 of the clutch cover 88 are engaged with the indentation portions 69.

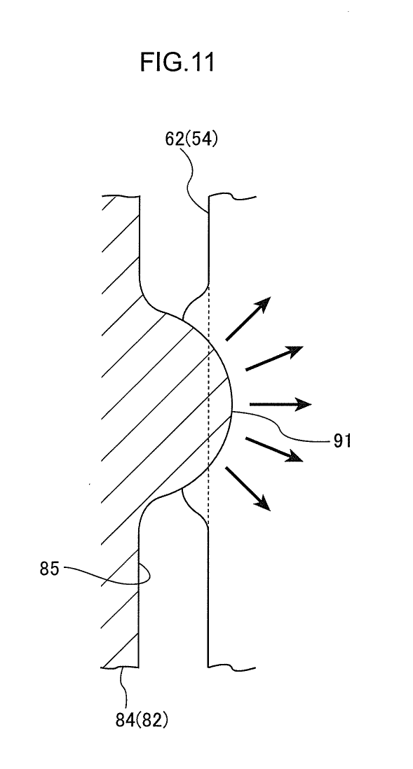

When press-insert the press insertion portion 62 of the sleeve 54 into the press insertion hole 85 of the clutch base 82, the press insertion portion 62 is inserted into the press insertion hole 85 from the leading end side (one end side). When this occurs, the three ribs 91 of the press insertion hole 85 are inserted from the sloping face 91A side into the three mutually non-adjacent indentation portions 67 out of the six indentation portions 67 of the press insertion portion 62. Then, as illustrated in FIG. 10A, when the sloping faces 91A of the plural ribs 91 make contact with (abuts with) the sloping faces 67A of the plural indentation portions 67, the load required to press-insert the press insertion portion 62 into the press insertion hole 85 increases. When the press insertion portion 62 is pushed from this state further into the press insertion hole 85, sliding contact portions of the press insertion portion 62 with the plural ribs 91 are deformed by the sloping faces 91 A of the ribs 91 making sliding contact with the outer peripheral face of the base end side (other end side) of the press insertion portion 62. In such case, as illustrated in FIG. 11, each portion at the base end side of the press insertion portion 62, where is in sliding contact with each of the ribs 91, deforms so as to bulge (build) up at both sides of the rib 91 due to the sloping face 91A of the rib 91 pressing (pushing) the each portion of the press insertion portion 62 towards the sleeve 54 radial direction inside. Namely, the rib 91 is press-inserted into the press insertion hole 85 while the portion of the press insertion portion 62 is pushed out around the rib 91 by the sloping face 91A.

When a hole edge portion 84B1 (abutted portion) of the press insertion hole 85, which is on the other thickness direction end face 84B of the clutch base 82 makes contact with (abuts with) a step portion 63 (abutting portion) between the press insertion portion 62 and the supporting portion 60 of the sleeve 54, the press insertion portion 62 cannot be press-inserted any further into the press insertion hole 85. The clutch base 82 is thereby positioned in the axial line direction with respect to the sleeve 54. In this state, the clutch base 82 is assembled to the sleeve 54 without rattling due to portions at the base end side of the press insertion portion 62 where are in sliding contact with the ribs 91 deforming in the manner described above. In this state, as illustrated in FIG. 10B, spaces 99 that are triangular shaped as viewed along the sleeve 54 circumferential direction are formed between the sloping faces 91A of the ribs 91 (the end faces of ribs 91, which are on the opposite side to the press insertion portion 62 insertion direction) and the step portion 63. Namely, configuration is such that the triangular shaped space 99 is formed between the sloping face 91A of the rib 91, the base end portion of the press insertion portion 62, and the step portion 63 since the width direction dimension W1 of the press insertion hole 85 is set larger than the width direction dimension W2 of the press insertion portion 62.

(Operation and Effect)

The operation and effects of the present first embodiment are described next. In the webbing retractor of the above-described structure, the webbing take-up shaft, namely, the spool 20, the lock gear 24, the main torsion shaft 32, the sub torsion shaft 44 and the clutch mechanism 52 (including the sleeve 54, the clutch base 82, the clutch plates 100 and the screw 108) are able to rotate integrally in the take-up direction and the pull-out direction.

Due to the webbing 22 being pulled-out from the spool 20, the webbing 22 is applied to the body of a passenger of the vehicle. In the state in which the webbing 22 is applied to the body of a passenger of the vehicle, when, for example, the vehicle enters into a state of rapid deceleration and the locking mechanism 33 operates, rotation of the lock gear 24 in the pull-out direction is impeded.

Due thereto, rotation, in the pull-out direction, of the spool 20 that is connected to the lock gear 24 via the main torsion shaft 32 is limited, and pulling-out of the webbing 22 from the spool 20 is limited. Accordingly, due thereto, the body of the passenger, that starts to move toward the vehicle front, is restrained by the webbing 22.

In the state in which rotation, in the pull-out direction, of the lock gear 24 is impeded, when the body of the passenger pulls the webbing 22 by an even greater force, and the rotational force of the spool 20 in the pull-out direction, that is based on this pulling force, exceeds the twist resisting load (the deformation resisting load) of the first energy absorbing portion 38 of the main torsion shaft 32, the force limiter mechanism 31 is operated. Due to the twisting (deformation) of the first energy absorbing portion 38, rotation, in the pull-out direction and that is greater than or equal to the force limiter load (the twist resisting load of the first energy absorbing portion 38), of the spool 20 is permitted.

Accordingly, due to the twisting of the first energy absorbing portion 38, the spool 20 is rotated in the pull-out direction, and the webbing 22 is pulled-out from the spool 20. Due thereto, the load (burden) on the chest portion of the passenger due to the webbing 22 is reduced, and the kinetic energy of the passenger, that is used to pull the webbing 22, is absorbed by an amount corresponding to the amount of twisting of the first energy absorbing portion 38.

On the other hand, as described above, the spool 20 being rotated in the pull-out direction with respect to the lock gear 24 means that the lock gear 24 is rotated in the take-up direction relative to the spool 20. Accordingly, when the lock gear 24 is rotated relative to the spool 20 in the take-up direction, the proximal end portion 40A of the trigger wire 40 is moved in the peripheral direction of the main torsion shaft 32 while the portion of the trigger wire 40, which portion is further toward the distal end side than the proximal end portion 40A, remains inserted in the hole portion 42 of the spool 20. Therefore, the portion of the trigger wire 40, which portion is further toward the distal end side than the proximal end portion 40A, is pulled toward the lock gear 24 side with respect to the hole portion 42.

Due thereto, the distal end portion 40B of the trigger wire 40 is pulled-out from the hole portion 65 of the clutch guide 64 and the hole portion 91 of the clutch cover 88, and the state, in which relative rotation of the clutch guide 64 with respect to the spool 20 and the clutch cover 88 is impeded, is cancelled.

Then, when the clutch guide 64 is rotated from the non operation position to the operation position due to the urging forces of the coil springs 98, the intervals between the hole portions 89 of the clutch cover 88 (the rotating shafts 106 of the clutch plates 100) and the connecting wall portions 74 of the clutch guide 64 become short, and the distal ends of the arc-shaped portions 104 of the clutch plates 100 are pushed (guided) in tangent directions of the clutch guide 64 by the connecting wall portions 74. Due thereto, the clutch plates 100 are rotated toward the lock ring 190 side (refer to arrow R in FIG. 4A), and the knurled teeth 104A of the clutch plates 100 mesh-together with the knurled teeth 190A of the lock ring 190 (the state shown in FIG. 4B). Due thereto, the clutch plates 100 and the lock ring 190 are joined. Further, at this time, due to the anchor portions 86, that are formed at the clutch base 82, pushing the proximal end portions of the arm portions 102 of the clutch plates 100 in the pull-out direction, the clutch plates 100 are pushed against the lock ring 190, and the state in which the clutch plates 100 and the lock ring 190 are joined is maintained. Due thereto, the lock ring 190 attempts to rotate in the pull-out direction integrally with the rotation in the pull-out direction of the clutch mechanism 52 (the sleeve 54, the clutch base 82, and the clutch plates 100).

Further, on the basis of a signal from the physique detection unit, the control device judges whether or not the physique of the passenger is greater than or equal to a predetermined reference value, and, on the basis of a signal from the collision detection unit, the control device judges whether or not the vehicle has collided. When the control devices judges that the physique of the passenger is greater than or equal to the predetermined reference value, the gas generator 194 is not operated, and therefore, the engaging portion 156 of the pawl 150 is disposed at the locking position and is engaged with the lock hole 192 of the lock ring 190. Thus, rotation of the lock ring 190 in the pull-out direction is locked (impeded), and due thereto, rotation of the clutch mechanism 52 (the sleeve 54, the clutch base 82 and the clutch plates 100) in the pull-out direction is impeded.

Further, in the state in which rotation, in the pull-out direction, of the sleeve 54, is impeded, when the body of the passenger pulls the webbing with even greater force, and the rotational force of the spool 20 in the pull-out direction that is based on this pulling force exceeds the total of the twist resisting load (the deformation resisting load) of the first energy absorbing portion 38 of the main torsion shaft 32 and the twist resisting load (the deformation resisting load) of the second energy absorbing portion 50 of the sub torsion shaft 44, due to the twisting (deformation) of the first energy absorbing portion 38 and the second energy absorbing portion 50, rotation, in the pull-out direction and that is greater than or equal to the force limiter load (the total of the twist resisting load of the first energy absorbing portion 38 and the twist resisting load of the second energy absorbing portion 50), of the spool 20 is permitted.

Accordingly, due to the spool 20 being rotated in the pull-out direction by the twisting the first energy absorbing portion 38 and the second energy absorbing portion 50, and the webbing 22 being pulled-out from the spool 20, the load (burden) on the chest portion of the passenger due to the webbing 22 is reduced, and the kinetic energy of the passenger, that is used to pull the webbing 22, is absorbed by an amount corresponding to the amounts of twisting of the first energy absorbing portion 38 and the second energy absorbing portion 50.

On the other hand, when the control device judges, on the basis of a signal from the physique detection unit, that the physique of the passenger is less than the predetermined reference value, and judges, on the basis of a signal from the collision detection unit, that the vehicle has collided, the gas generator 194 is operated by control of the control device.

When the gas generator 194 is operated, gas is supplied from the gas generator 194 into the cylinder portion 140 of the piston accommodating portion 136. When gas is supplied into the cylinder portion 140, the piston 160 moves toward the arm portion 154 side of the pawl 150 and pushes the arm portion 154. Therefore, rotational force around the shaft portion 152 is applied to the pawl 150. Due to this rotational force, the inner peripheral portion of the anchor hole 158 of the pawl 150 abuts the shear pin 134 and breaks the shear pin 134, and due thereto, rotation of the pawl 150 around the shaft portion 152 is permitted, and the pawl 150 is rotated from the locking position to the releasing position. Due thereto, the engaging portion 156 of the pawl 150 moves away from the lock hole 192 of the lock ring 190, and rotation of the lock ring 190 in the pull-out direction is permitted. Due thereto, the lock ring 190 is made able to rotate in the pull-out direction together with the clutch mechanism 52 (the sleeve 54, the clutch base 82 and the clutch plates 100) and the spool 20. Therefore, twisting does not arise at the second energy absorbing portion 50, and thus, due to the twisting (deformation) of the first energy absorbing portion 38, rotation, in the pull-out direction and of greater than or equal to the force limiter load (the twist resisting load of the first energy absorbing portion 38), of the spool 20 is permitted.

Namely, when the physique of the passenger is greater than or equal to the predetermined reference value, the force limiter load is made to be the total of the twist resisting load of the first energy absorbing portion 38 and the twist resisting load of the second energy absorbing portion 50, and the load value of the force limiter load is made to be a high load. On the other hand, when the physique of the passenger is less than the predetermined reference value and collision of the vehicle is detected, the force limiter load is made to be the twist resisting load of the first energy absorbing portion 38, and the load value of the force limiter load is made to be a low load. Therefore, the passenger can be protected appropriately in accordance with his/her physique.

In the present exemplary embodiment, the press insertion portion 62 of the sleeve 54 provided to the webbing take-up shaft 11 is press inserted from the leading end side into the press insertion hole 85 of the clutch base 82, and the step portion 63 (abutting portion) provided on the base end side of the press insertion portion 62 makes contact with the abutted portion of the clutch base 82. The clutch base 82 is formed from a material harder than the sleeve 54.

The ribs 91 are provided at the press insertion hole 85 of the clutch base 82 on faces facing the press insertion portion 62 of the sleeve 54, enabling rattling between the sleeve 54 and the clutch base 82 to be suppressed by the ribs 91. The end faces of the ribs 91 on the opposite side to the press insertion direction of the press insertion portion 62 are configured by the sloping faces 91A that slope along the press insertion direction of the press insertion portion 62. Thus, the sloping faces 91A of the ribs 91 make sliding contact with the press insertion portion 62 when the press insertion portion 62 is being press inserted into the press insertion hole 85. In this case, the portion of the press insertion portion 62 is pushed out around the rib 91 by the sloping face 91A as the rib 91 is press-inserted into the press insertion hole 85. Burrs from cutting the press insertion portion 62 by the ribs 91 can accordingly be prevented or suppressed from generating. Load when the press insertion portion 62 is press-inserted into the press insertion hole 85 can also be made smaller, enabling the press insertion portion 62 to be readily press-inserted into the press insertion hole 85.

Moreover, in the present exemplary embodiment, due to being able to prevent or suppress burrs from generating as described above, burrs can be prevented from becoming trapped (sandwiched) between the step portion 63 and the hole edge portion 84B1 of the press insertion hole 85. As a result good assembly precision in the axial line direction can be achieved between the sleeve 54 and the clutch base 82, so enabling, for example, the engagement precision to be raised when the clutch plates 100 are engaged with the lock ring 190 by the clutch base 82.

Moreover, in the present exemplary embodiment, the space 99 is formed between the sloping face 91A of the rib 91 and the step portion 63 of the sleeve 54. Hence even if a burr was to be generated on the press insertion portion 62 due to sliding contact between the sloping face 91A of the rib 91 and the press insertion portion 62, such a burr could be trapped (closed) inside the space 99. As a result burr can be effectively prevented from getting sandwiched between the step portion 63 of the sleeve 54 and the hole edge portion 84B1 of the press insertion hole 85 of the clutch base 82.

Moreover, in the present exemplary embodiment, the ribs 91 provided at the press insertion hole 85 are inserted into the indentation portions 67 formed at the leading end side of the press insertion portion 62 when the press insertion portion 62 of the sleeve 54 is being press inserted from the leading end side into the press insertion hole 85 of the clutch base 82. In the indentation portions 67, the end faces of the indentation portions 67 at the opposite side to the press insertion portion 62 insertion direction are configured as the sloping faces 67A, the sloping faces 67A sloping such that the indentation portions 67 become shallower towards the base end side of the press insertion portion 62. Burrs are accordingly suppressed from generating due to sliding contact of the sloping faces 67A of the indentation portions 67 against the sloping faces 91A of the ribs 91 when the base end side of the press insertion portion 62 is being press inserted into the press insertion hole 85 (when the ribs 91 are coming out from the indentation portions 67). Namely, in case in which step portions (corner portions, for example, vertical portions) were formed in place of the above sloping faces 67A at the indentation portions 67, there would be the possibility of burrs generating due to these step portions (corner portions) being cut by the ribs 91, however this can be avoided in the present exemplary embodiment. Moreover, since bulging up of the press insertion portion 62 in the vicinity of the sloping faces 67A of the indentation portions 67 accompanying forming the indentation portions 67 can be suppressed from occurring in a case in which the sleeve 54 is for example formed by forging, burrs can also be suppressed from generating due to sliding contact between such raised portions and the ribs 91.

Moreover, in the present exemplary embodiment, the end faces of the ribs 91 formed to the press insertion hole 85 on the opposite side to the press insertion direction of the press insertion portion 62 are configured with sloping faces 91A rather than with curved faces, and so the sloping faces 91A make sliding contact with the press insertion portion 62. In this case, since the sliding contact angle between the sloping face 91A of the rib 91 and the press insertion portion 62 can be made constant, the manner in which a portion of the press insertion portion 62 in sliding contact with the rib 91 deforms can be stabilized.

Next, explanation follows regarding other exemplary embodiment of the present invention. Note that configuration and operation that is basically the same as that of the first exemplary embodiment is allocated the same reference numerals as those of the first exemplary embodiment and further explanation thereof is omitted.

### Second Exemplary Embodiment

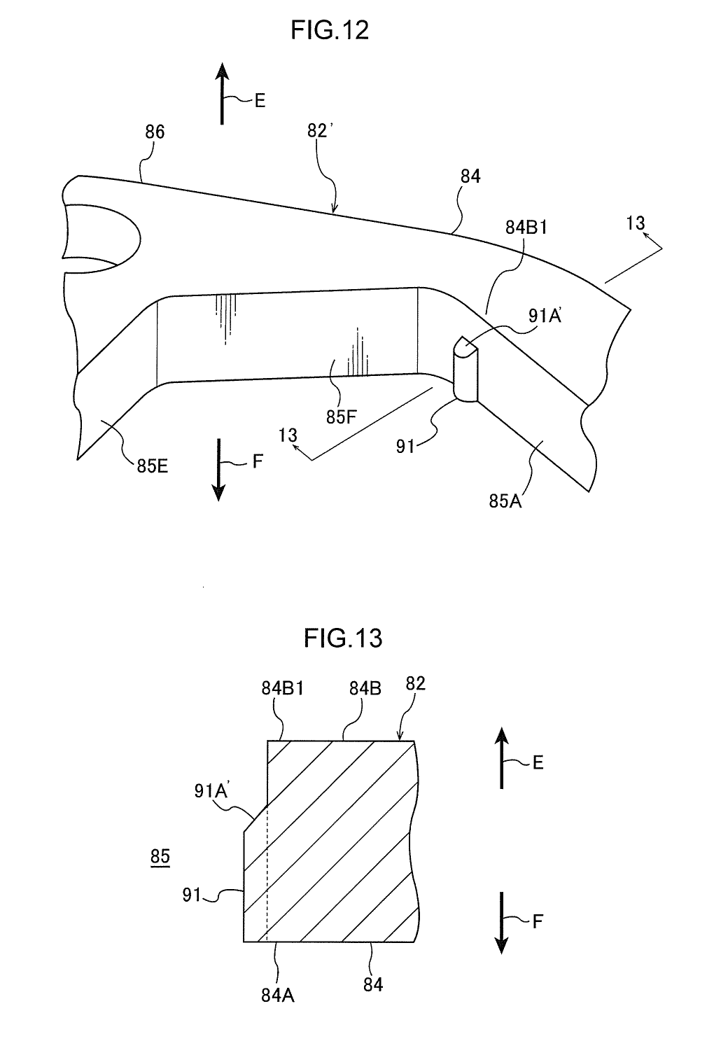

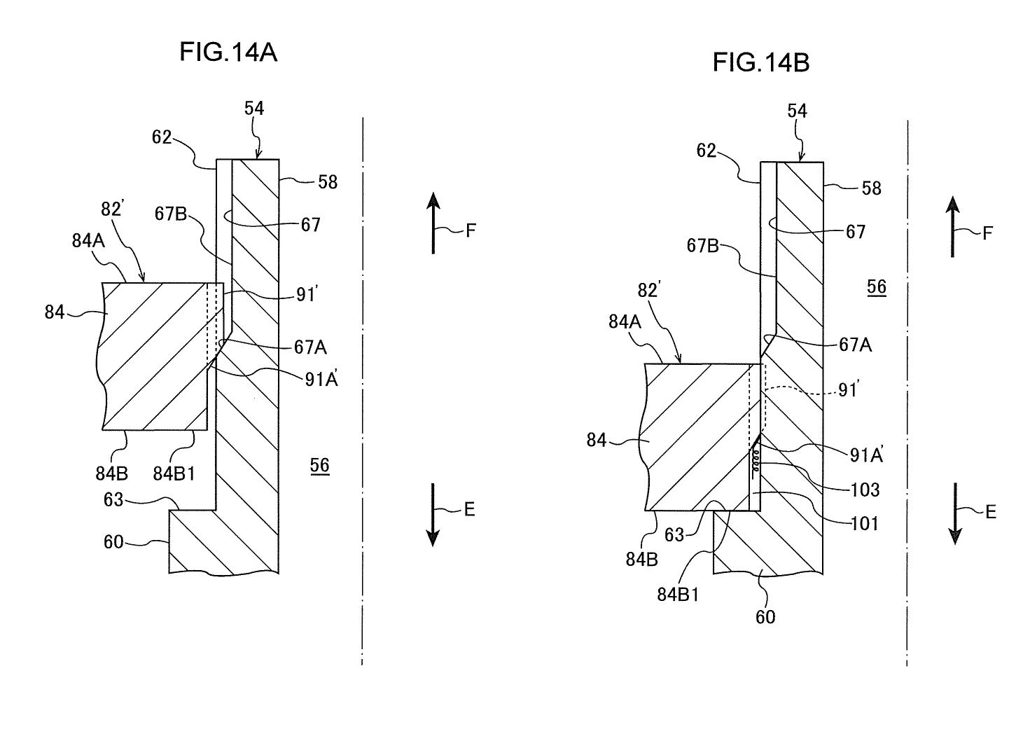

FIG. 12 is a perspective view corresponding to FIG. 7 that illustrates a portion of a clutch base 82′ that is a configuration member of a webbing retractor according to a second exemplary embodiment of the present invention. FIG. 13 is a cross-section taken along line 13-13 of FIG. 12. This exemplary embodiment is configured basically the same as the first exemplary embodiment, but ribs 91′ of the clutch base 82′ differ from the ribs 91 according to the first exemplary embodiment. The ribs 91′ are configured basically the same as the ribs 91 of the first exemplary embodiment, except that sloping faces 91A′ that are the end faces of the ribs 91′ on the opposite side to the press insertion portion 62 press insertion direction (to the arrow F direction of FIG. 13 and FIG. 14) are provided separated in the press insertion direction from a hole edge portion 84B1 (abutted portion) of a press insertion hole 85 of the clutch base 82′. Thus in the press-inserted state of the press insertion portion 62 in the press insertion hole 85, as illustrated in FIG. 14B, trapezoidal spaces 101 are formed between the sloping faces 91A′ of the ribs 91′ and the step portion 63 of the sleeve 54 as viewed along the sleeve 54 circumferential direction.

Other parts of the configuration of the present exemplary embodiment are configured similarly to in the first exemplary embodiment. Basically the same operation and advantageous effects are accordingly exhibited to those of the first exemplary embodiment. Further, due to the sloping faces 91A′ of the ribs 91′ being provided separated in the press insertion direction of the press insertion portion 62 from the hole edge portion 84B1 of the press insertion hole 85, the spaces 101 formed between the sloping faces 91A′ and the step portion 63 are larger than the spaces 99 according to the first exemplary embodiment. Therefore, as illustrated in FIG. 14B, even supposing a burr 103 was to be generated on the press insertion portion 62 due to sliding contact between the rib 91′ and the press insertion portion 62, the burr 103 can be well confined (pocketed) within the space 101. As a result, good assembly precision can be achieved between the sleeve 54 and the clutch base 82 due to being able to prevent the burr 103 from becoming trapped (sandwiched) between the step portion 63 of the sleeve 54 and the hole edge portion 84B1 of the press insertion hole 85 of the clutch base 82.

Moreover, due to providing the sloping faces 91A′ of the ribs 91′ at positions separated from the hole edge portion 84B1 of the press insertion hole 85, the length of sliding contact of the ribs 91′ with the press insertion portion 62 can be made shorter. Thus even were a burr 103 to be generated by sliding contact between the rib 91′ and the press insertion portion 62, the volume of the burr 103 can be made smaller, with this being effective in such situations as when the press insertion stroke of the press insertion portion 62 with respect to the press insertion hole 85 is longer.

### Third Exemplary Embodiment

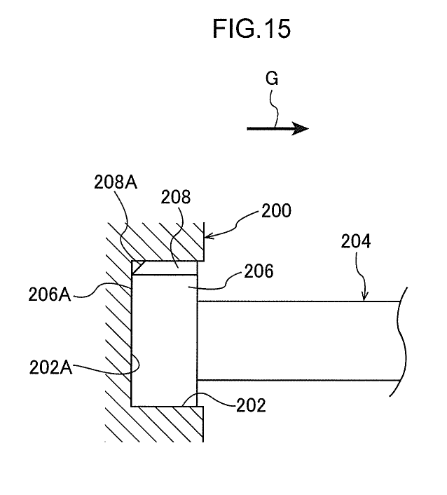

FIG. 15 is a cross-section illustrating a configuration of part of a webbing retractor according to a third exemplary embodiment of the present invention. In the present exemplary embodiment, a press insertion portion 202 (hole portion) is provided at an axial center portion of a spool 200 that serves as a press insertion member is press-inserted (press-fit) from an opening side over a pressed insertion portion 206 that is provided at one axial direction end portion of a torsion shaft 204 serving as a pressed insertion member. The torsion shaft 204 is formed from a metal material harder than the spool 200. Ribs 208 are also provided to an outer peripheral face of the pressed insertion portion 206 (a face that faces the press insertion portion 202). An end face of the rib 208 on the opposite side to the press insertion direction of the press insertion portion 202 (to the arrow G direction of FIG. 15) is configured as a sloping face 208A (C (chamfer) face) that slopes along the press insertion direction. The torsion shaft 204 is positioned in the axial line direction with respect to the spool 200 by abutting between a bottom face 202A (abutting portion) of the press insertion portion 202 of the spool 200 and a leading end face 206A (abutted portion) of the pressed insertion portion 206 of the torsion shaft 204.

In the present exemplary embodiment, rattling between the spool 200 and the torsion shaft 204 can be suppressed by the ribs 208 provided to the pressed insertion portion 206 of the torsion shaft 204. Moreover, due to the end face on the opposite side to the press insertion portion 202 press insertion direction of the rib 208 being configured by the sloping face 208A, the sloping face 208A of the rib 208 makes sliding contact with the inner peripheral face of the press insertion portion 202 when the press insertion portion 202 is press-inserted onto the pressed insertion portion 206. Thus similarly to in each of the above exemplary embodiments, due to preventing or suppressing burrs from being generated on the press insertion portion 202, burrs can be prevented from becoming trapped (sandwiched) between the bottom face 202A (abutting portion) of the press insertion portion 202 and the leading end face 206A (abutted portion) of the pressed insertion portion 206. As a result, good assembly precision can be achieved in the axial direction between the spool 200 and the torsion shaft 204.

Supplementary Explanation to each of the Exemplary Embodiments

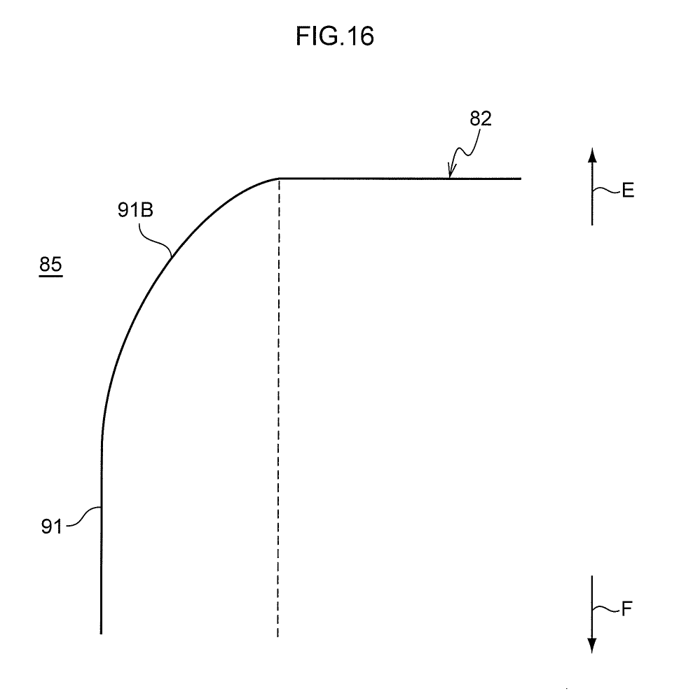

In each of the exemplary embodiments, configuration is made with the sloping faces 91A, 91A, 208A provided to the ribs 91, 91′, 208 on the end faces on the opposite side to the press insertion direction of the press insertion portion 62, 202, however the present invention is not limited thereto. Configuration may be made such that the end faces of the ribs 91, 91′, 208 on the opposite side to the press insertion direction of the press insertion portion 62, 202 are curved faces 91B that curve along the press insertion direction of the press insertion portion 62, 202 (FIG. 16). In such cases the press insertion portion 62, 202 can also be prevented or suppressed from being cut by the ribs 91, 91′, 208, and so burrs can prevented or suppressed from being generated at the press insertion portion 62, 202.

Moreover, in each of the exemplary embodiments explanation has been given of cases in which the sleeve 54 and the spool 200 serve as press insertion members, and the clutch base 82, 82′ and the torsion shaft 204 serve as pressed insertion members. However the present invention is not limited thereto and configuration may be made such that the press insertion member and the pressed insertion member are provided to a webbing take-up shaft. For example, in each of the exemplary embodiments, configuration may be made such that the main torsion shaft 32 serves as the press insertion member, and the lock gear 24 serves as the pressed insertion member. In such cases configuration is made such that the first engagement portion 34 of the main torsion shaft 32 serves as the press insertion portion, and the engaged portion 30 (the through hole 28) of the lock gear 24 serves as the pressed insertion member, and rib(s) are formed to the inner peripheral face of the engaged portion 30.

Moreover, although in the first and the second exemplary embodiments configuration is made with the indentation portions 67 formed to the press insertion portion 62 of the sleeve 54, the present invention is not limited thereto and configuration may be made with the indentation portions 67 omitted.

In addition, various other modifications may be implemented in the present invention within a scope not departing from the spirit of the present invention. Moreover, it should be understood that the scope of rights of the present invention is not limited by the above exemplary embodiments.

What is claimed is:

1. A webbing retractor comprising:
a press insertion member that is provided at a webbing take-up shaft supported rotatably at a frame, and that includes a press insertion portion; and
a pressed insertion member that is formed from a material harder than the press insertion member, and that includes a pressed insertion portion to which the press insertion portion is press-inserted, and a rib that is provided on a face of the pressed insertion portion facing the press insertion portion,
wherein an end face of the rib, which end face is on the opposite side to a press insertion direction of the press insertion portion to the pressed insertion portion, is a sloping face that slopes along the press insertion direction or is a curved face that curves along the press insertion direction.

2. The webbing retractor of claim 1, wherein:
the press insertion portion is press-inserted to the pressed insertion portion from one end side of the press insertion portion, and
an abutting portion for positioning, that is provided at another end side of the press insertion portion, abuts an abutted portion which is provided at the pressed insertion member.

3. The webbing retractor of claim 2, wherein a space is formed between the end face of the rib and the abutting portion.

4. The webbing retractor of claim 3, wherein the end face of the rib is provided so as to be separated, in the press insertion direction, from the abutted portion.

5. The webbing retractor of claim 1, wherein:
the press insertion portion is press-inserted to the pressed insertion portion from one end side of the press insertion portion,
a concave portion is formed at the one end side of the press insertion portion, into which the rib is inserted when the press insertion portion is press-inserted to the pressed insertion portion; and
an end face of the concave portion on the opposite side to the press insertion direction of the press insertion portion is configured by a sloping face that slopes such that the concave portion becomes shallower on progression towards another end side of the press insertion portion.

6. The webbing retractor of claim 2, wherein:
a concave portion is formed at the one end side of the press insertion portion, into which the rib is inserted when the press insertion portion is press-inserted to the pressed insertion portion; and
an end face of the concave portion on the opposite side to the press insertion direction of the press insertion portion is configured by a sloping face that slopes such that the concave portion becomes shallower on progression towards the other end side of the press insertion portion.

7. The webbing retractor of claim 3, wherein:
a concave portion is formed at the one end side of the press insertion portion, into which the rib is inserted when the press insertion portion is press-inserted to the pressed insertion portion; and
an end face of the concave portion on the opposite side to the press insertion direction of the press insertion portion is configured by a sloping face that slopes such that the concave portion becomes shallower on progression towards the other end side of the press insertion portion.

8. The webbing retractor of claim 4, wherein:
a concave portion is formed at the one end side of the press insertion portion, into which the rib is inserted when the press insertion portion is press-inserted to the pressed insertion portion; and
an end face of the concave portion on the opposite side to the press insertion direction of the press insertion portion is configured by a sloping face that slopes such that the concave portion becomes shallower on progression towards the other end side of the press insertion portion.

9. The webbing retractor of claim 1, wherein:
the webbing take-up shaft comprises a spool on which webbing is taken up, and a torsion shaft that has one end portion connected to the spool;
the press insertion member is a sleeve that is attached to another end portion of the torsion shaft; and
the pressed insertion member is a clutch base that is attached to the sleeve and that connects a ring portion provided on a side of the frame and the sleeve via a pawl.

10. The webbing retractor of claim 1, wherein:
the rib is formed so as to protrude from the pressed insertion portion toward a side of the press insertion portion, and
a protruding height of the sloping face of the rib or the curved face of the rib becomes lower on progression towards the opposite side to the press insertion direction of the press insertion portion.

11. The webbing retractor of claim 9, wherein:
the pressed insertion portion is a hole that passes through the pressed insertion member in an axial direction of the webbing take-up shaft,
the rib is formed so as to protrude from an inner peripheral face of the hole toward a side of an outer peripheral face of the press insertion portion, and
a protruding height of the sloping face of the rib or the curved face of the rib becomes lower on progression towards the opposite side to the press insertion direction of the press insertion portion.

12. The webbing retractor of claim 1, wherein:
the webbing take-up shaft comprises a spool on which webbing is taken up, and a torsion shaft that is connected to the spool;
the press insertion member is the spool,
the pressed insertion member is the torsion shaft, and
the rib is formed on the pressed insertion portion provided at an end portion in an axial direction of the torsion shaft.

13. The webbing retractor of claim 12, wherein:
the press insertion portion is a hole portion that is provided at an axial center portion of the press insertion member,
the rib is formed so as to protrude from an outer peripheral face of the pressed insertion portion toward a side of an inner peripheral face of the hole portion, and
a protruding height of the sloping face of the rib or the curved face of the rib becomes lower on progression towards the opposite side to the press insertion direction of the press insertion portion.
